(19) United States
(12) Patent Application Publication
(10) Pub. No.: US 2009/0265466 A1
(43) Pub. Date: Oct. 22, 2009

(54) DATA PROVIDING SYSTEM, DATA PROVIDING METHOD, SERVER, NETWORK SYSTEM, AND PROGRAM

(75) Inventor: Masato Yoshikawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/088,197

(22) PCT Filed: Sep. 22, 2006
(86) PCT No.: PCT/JP2006/318848

§ 371 Date: Mar. 26, 2008

(30) Foreign Application Priority Data
Sep. 27, 2005 (JP) 2005-280827

(51) Int. Cl. G06F 15/173

(52) U.S. Cl. 709/226; 709/246

(57) ABSTRACT

[Problems to be Solved] A function is provided of reducing traffic without performing retransmission of data already held in a mobile terminal at the moment of utilizing a Web browser-based service.

[Means to Solve the Problems] A server preserves a template having an extension tag constituting a Web page transmitted to the mobile terminal and a data history together with an ID in a cache, at the time of transmitting information to the mobile terminal, makes a reference to the information in the cache, and in a case where the information has been already transmitted, transmits only the ID indicating its information. The mobile terminal takes out the template and the data based upon the ID with which the information preserved in the cache has been received, and reconstitute the Web page by the extension tag attached to the template. This makes it possible to reduce traffic without performing retransmission of the information already transmitted to the mobile terminal and held by the mobile terminal at the moment of utilizing the Web browser.

### APPLICABLE FIELD IN THE INDUSTRY

The present invention relates to a technology of reducing a quantity of data being transmitted from a server to a mobile terminal in a web browser being utilized by the mobile terminal, and more particularly to a technology of suppressing retransmission of data already held in the mobile terminal by utilizing a contents management technique and a data transmission history.

### BACKGROUND ART

Conventionally, as a technique of this type for reducing a transmission data quantity at the moment of utilizing a browser function, there exists, for example, the technology disclosed in JP-P2002-215448A.

A configuration of the technology disclosed in Patent document is shown in FIG. 13. The mobile terminal preserves URL of Web pages to which a reference has been made in a favorite folder 1320, and preserves a contents of its Web page in a cache region 1332 of a cache memory 1330 being held by this mobile terminal. At the time of the a reference to the Web page made after a this-time reference, if the URL of an access destination exists in the favorite folder 1320, the mobile terminal requests update information of a server of a reference destination. When the mobile terminal acquires the update information and determines that the update is unnecessary, it reads out the web contents preserved in the cache memory 1330, and displays the contents in a display unit 1307. Further, if the mobile terminal determines that the update is necessary, it request the Web contents of the server of a reference destination once again, updates the cache region 1332 of the cache memory 1330, and displays the contents in the display unit 1307.

[Patent document 1] JP-P2002-215448A

### DISCLOSURE OF THE INVENTION

### Problems to be Solved by the Invention

In the technology of the Patent document 1, the server side providing the Web contents does not grasp which data the mobile terminal holds, whereby a waste of traffic accompanied by requesting the Web contents again occurs in a case where the data has been updated as a result of the mobile terminal inquiring of the server the update of the data. Further, an occurrence of a change to one part of information (even if one character) within the Web contents is interpreted as an occurrence of the update of the text of the Web contents, and resultantly, all Web contents are transmitted, which also causes a waste of the traffic to occur.

### Means for Solve the Problem

The data providing system of the present invention for solve the above-mentioned problems, which is a data providing system for providing data responding to a terminal's service request, is characterized in including: a first storing means in which service date that is plurally divided and is updated for each divided division data has been stored; and a providing means for attaching an identifier to the division data responding to a first-time service request by the terminal, providing to the terminal the division data to which the identifier has been attached, comparing the service data of the first storing means with the service date being comprised of the division data transmitted to the terminal responding to a service request made after the first-time one by the terminal, newly attaching an identifier to the updated division data out of the service data, and providing to the terminal this division data to which the identifier has been newly attached.

Further, the another data providing system of the present invention, which is a data providing system for providing a service responding to a terminal's service request, is characterized in including: a first storing means in which service date that is plurally divided and is updated for each divided division data has been stored; a second storing means for preserving the division data of the transmitted service data together with an identifier responding to a request for the service; and a providing means for comparing the service data stored in the first storing means with the service data stored in the second storing means, in a case where the service data stored in the first storing means has been updated, attaching a new identifier to the division data of this updated service data to store it in the second storing means, and providing its division data together with the identifier to the terminal.

Further, the data providing method of the present invention, which is a data providing method of providing a service responding to a terminal's service request, is characterized in storing division data obtained by dividing data of the service being provided, attaching an identifier to the division data constituting the service data of the service responding to a first-time service request by the terminal, transmitting to the terminal the service data to which the identifier has been attached, comparing the service data of the storing means with the service data transmitted to the terminal responding to a service request made after the first-time one by the terminal, and transmitting the updated division data together with identifier to the terminal.

Further, the another data providing method of the present invention, which is a data providing method of providing to a terminal service data that is plurally divided and is updated for each division data, is characterized in, at the moment of providing the service data, attaching an identifier for each division data obtained by dividing the service data to transmit it to the terminal, preserving the transmitted division data together with the identifier, comparing the updated service data with the division data, which has been stored at the time of the transmission, newly attaching an identifier to the updated division data to transmit it to the terminal, and storing the updated division data and its identifier.

Further, the server of the present invention, which is a server for transmitting to a terminal data of a service being comprised of plural pieces of division data stored in a storing means, is characterized in including: the storing means; and a transmitting means for attaching an identifier to the division data constituting the service data of the service responding to a first-time service request by the terminal, transmitting to the terminal the service data to which the identifier has been attached, comparing the service data of the storing means with the service data transmitted to the terminal responding to a service request made after the first-time one by the terminal, and transmitting the updated division data together with the identifier to the terminal.

Further, the another server of the present invention, which is a server for transmitting to a terminal service data that is stored in a data server and is updated for each division data plurally divided, is characterized in including: a storing means in which the service date transmitted to the terminal is stored with an identifier attached for each division data; an update confirming means for comparing the service data of the data server with the service data stored in the storing means for each division data to confirm whether the service data of the data server has been updated; and a providing means for, in a case where it has been confirmed by the update confirming means that the service data of the data server has been updated, attaching a new identifier to the division data of the updated service data to cause the storing means to store it, and providing the updated division data together with the identifier to the terminal.

Further, the data server of the present invention, which is a data server for providing data to a main server transmitting updated data together with an identifier to a terminal, is characterized in including: a storing means in which division data obtained by dividing data corresponding to a service so that the main server is enabled to identify the updated data has been stored; an update managing means for managing an update of the division data for each of the division data; and a transmitting means for transmitting the division data stored in the storing means responding to a request for the data that corresponds to the service by the main server.

The data providing system of the present invention includes: a first storing means in which service data that is plurally divided and is updated for each divided division data has been stored; a second storing means for, responding to a request for a service, preserving the division data of the transmitted service data together with an identifier; and a providing means for comparing the service data stored in the first storing means with the service data stored in the second storing means, in a case where the service data stored in the first storing means has been updated, attaching a new identifier to the division data of this updated service data to store it in the second storing means, and providing its division data together with the identifier to the terminal.

The present invention, which is configured as mentioned above, makes it possible to reducing traffic between the providing means and the terminal because, in a case where a service request has been made by the terminal, the division data itself as well is transmitted to the terminal if the updated data exists, but only identifier attached to the division data is transmitted to the terminal if no updated data exists.

### AN ADVANTAGEOUS EFFECT OF THE INVENTION

The advantageous effect of the invention present lies in a point that traffic can be reduced because, at the moment of providing information, an information-providing side does not provide information held by an information-receiving side again. For example, in the utilization of Web browsing, the main server does not re-transmit information once transmitted to the mobile terminal and already held by the mobile terminal, thereby enabling traffic to be reduced.

The reason is that provision information, which is plurally divided and is provided to the information-receiving side, is pre-preserved in the storing means as well, the provision information preserved by the storing means and the provision information already preserved by the information-receiving side are compared with each other for each divided information before re-providing the provision information, and only information that has not been preserved by the information-receiving side is provided for each divided information.

For example, the main server side preserves a template having an extension tag constituting a web page transmitted to the mobile terminal, and a data history together with an ID in a cache. And, when the main server transmits information to the mobile terminal, it makes a reference to information within the cache, and with already-transmitted information, transmits only the ID indicating its information. On the other hand, the mobile terminal takes out the template and the data based upon the ID with which the information preserved in the cache has been received, and reconstitutes the Web page by the extension tag attached to the template.

### BRIEF DESCRIPTION OF THE DRAWINGS

FIG. 1 is a block diagram illustrating a configuration of a first exemplary example of the present invention.

FIG. 2 is a view illustrating an operational sequence of the first exemplary example of the present invention.

FIG. 3 is a view illustrating an operational sequence of the first exemplary example of the present invention.

FIG. 4 is a view illustrating a service definition, a display template, and a data unit that are utilized in the first exemplary example of the present invention.

FIG. 5 is a view illustrating an operational flow of the first exemplary example of the present invention.

FIG. 6 is a second view illustrating an operational flow of the first exemplary example of the present invention.

FIG. 7 is a block diagram illustrating a configuration of a second exemplary example of the present invention.

FIG. 8 is a block diagram illustrating an operation of a third exemplary example of the present invention.

FIG. 9 is a view illustrating a template and a web page that are utilized in the third exemplary example of the present invention.

FIG. 10 is a view illustrating an operational flow of the third exemplary example of the present invention.

FIG. 11 is a block diagram illustrating an operation of a fourth exemplary example of the present invention.

FIG. 12 is a block diagram illustrating an operation of the fourth exemplary example of the present invention.

FIG. 13 is a block diagram illustrating a conventional configuration.

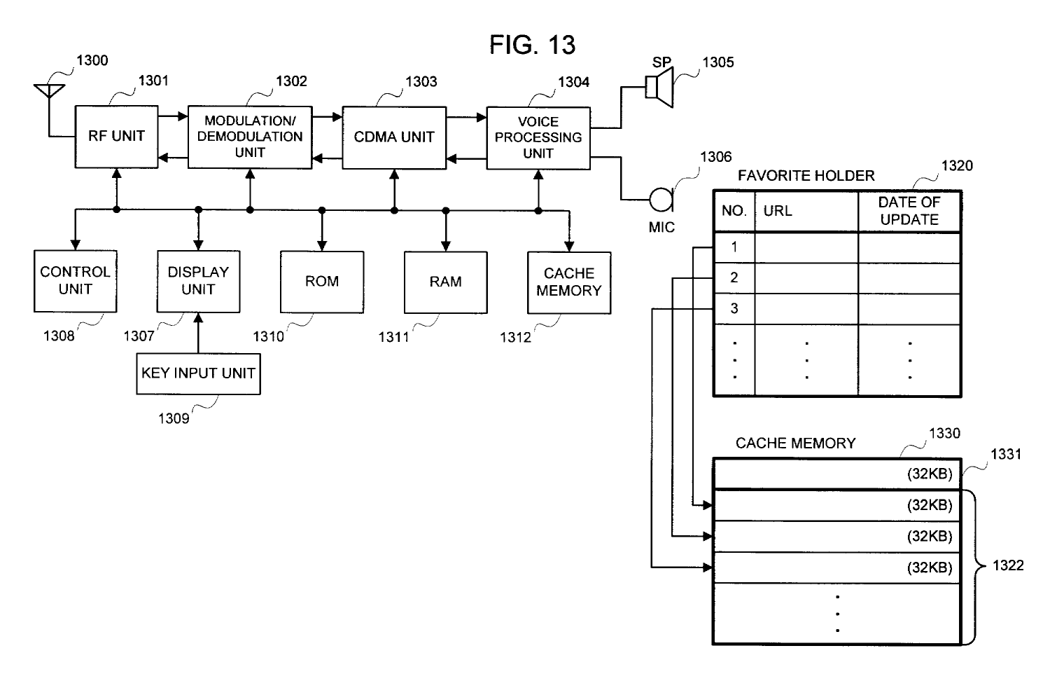

FIG. 14 is a block diagram illustrating a configuration of an exemplary embodiment of the present invention.

### DESCRIPTION OF NUMERALS

100 mobile terminal
101 service providing unit
102 efficiency control unit
103 communication control unit
104 reception data cache unit
110 main server
111 communication control unit
112 service processing unit
113 efficiency control unit
114 transmission data cache unit
115 service A region
116 ID X
117 cache template unit
118 ID A
119 cache data unit
120 data server
121 communication control unit
122 data acquisition unit
123 data management unit
124 service definition
125 template unit
126 data unit
200 service definition
201 template unit
202 data unit
210 history service definition
211 service A region
212 ID X
213 transmission template unit
214 ID A
215 transmission history data A
216 ID B
217 transmission history data B
218 ID C
219 transmission history data C
220 transmission service definition
221 ID X
222 transmission template
223 ID A
224 transmission history data A
225 ID B
226 transmission history data B
227 ID C
228 transmission history data C
230 reception service definition
231 service A region
232 ID X
233 reception template
234 ID A
235 reception data A
236 ID B
237 reception data B
238 ID C
239 reception data C
300 service definition
301 template unit
302 data unit
310 history service definition
311 service A region
312 ID X
313 transmission template
314 ID A
315 transmission history data A
316 ID B
317 transmission history data B
318 ID C
319 transmission history data C
320 ID D
321 new history data D
330 ID X
331 ID B
332 ID C
333 ID D
334 new data D
340 reception service definition
341 service A region
342 ID X
343 reception template
344 ID A
345 reception data A
346 ID B
347 reception data B
348 ID C
349 reception data C
350 ID D
351 new data D
400 extension tag <ext:service>
401 extension tag <ext:page>
410 extension tag <ext:loop>
411 extension tag <ext:useitem>
420 extension tag <ext:cachedata>
421 extension tag <ext:record>
422 extension tag <ext:item>
500 mobile terminal: a process flow by a service providing unit
501 process start step
502 information request step
503 information acquisition step
504 information generation step
505 process finish step
510 mobile terminal: a process flow by an efficiency control unit
511 process start step
512 information request step
513 information acquisition step
514 reception information text confirmation step
515 service region preparation step
516 data preservation step
517 data deletion/update/addition step
518 data ID providing step
519 process finish step
600 main server: a process flow by a service processing unit
601 process start step
602 information request step
603 information acquisition step
604 information transmission step
605 process finish step
610 main server: a process flow by an efficiency control unit
611 process start step
612 information request step
613 information acquisition step
614 service region confirmation step
615 service comparison step
616 data update/addition step
617 updated data/new data providing step
618 suit-of-data ID providing step
619 service region preparation step
620 data preservation step
621 data providing step
622 process finish step
700 service definition
701 template unit
702 data unit
710 history service definition
711 service A region
712 ID X
713 transmission template
714 individuality A region
715 ID A
716 transmission history data A
717 ID B
718 transmission history data B
719 individuality B region
720 ID C
721 transmission history data C
800 collation template
801 Web page
810 data-unit extraction unit
900 collation template (c-HTML)
910 Web page
1000 collation template load start step
1001 <ext:loop> tag detection step
1002 anterior-stage information preservation step
1003 </ext:loop> tag detection step
1004 pattern matching information detection step
1005 posterior-stage information preservation step
1006 Web page load step
1007 anterior-stage/posterior-stage information deletion step
1008 pattern matching process step
1009 difference information (data unit) extraction step
1100 main server
1101 efficiency control unit
1102 transmission data cache unit
1103 network monitoring unit
1104 contracting enterprise A
1105 data server A
1106 mobile terminal A
1107 contracting enterprise B
1108 data server B
1109 mobile terminal B
1200 main server
1201 network monitoring unit
1202 efficiency control unit
1203 transmission data cache unit
1204 traffic count management unit
1205 mobile terminal
1206 mobile terminal
1207 contracting enterprise A
1208 data server A
1209 contracting enterprise B
1210 data server B
1300 antenna
1301 RF unit
1302 modulation/demodulation unit
1303 CDMA unit
1304 voice processing unit
1305 speaker (SP)
1306 microphone (MIC)
1307 display unit
1308 control unit
1309 key input unit
1310 ROM
1311 RAM
1312 cache memory
1320 favorite folder
1330 cache memory
1331 and 1332 cache regions

### BEST MODE FOR CARRYING OUT THE INVENTION

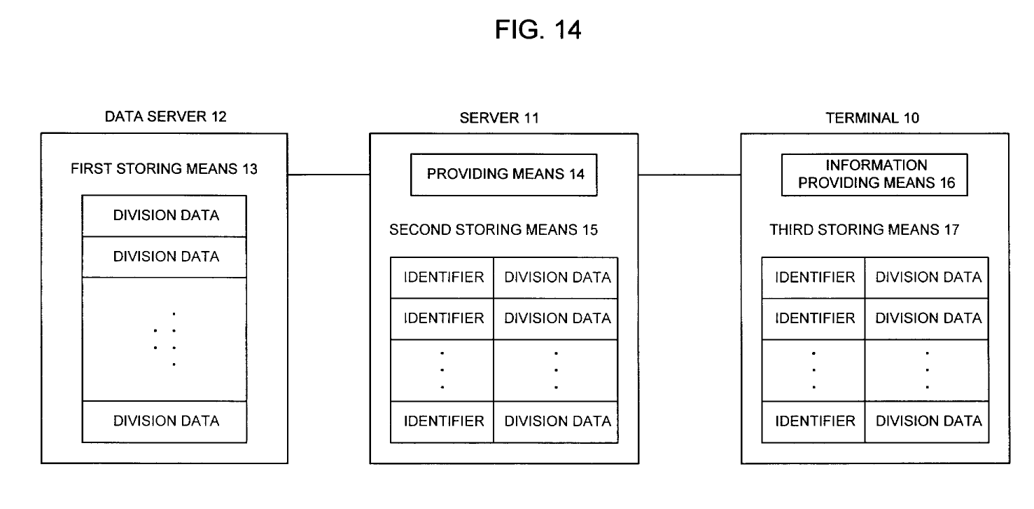

An exemplary embodiment of the present invention will be explained by employing FIG. 14.

The service data that is provided to a terminal 10 via a server 11 from a data server 12 responding to a service request by a terminal 10 is stored as division data with it divided in a first storing unit 13 of the data server 12. In a case where a necessity for performing the update such as the addition and the deletion for certain division data has occurred, only the division data, which need to be updated, is updated, so an influence is not exerted over the other data.

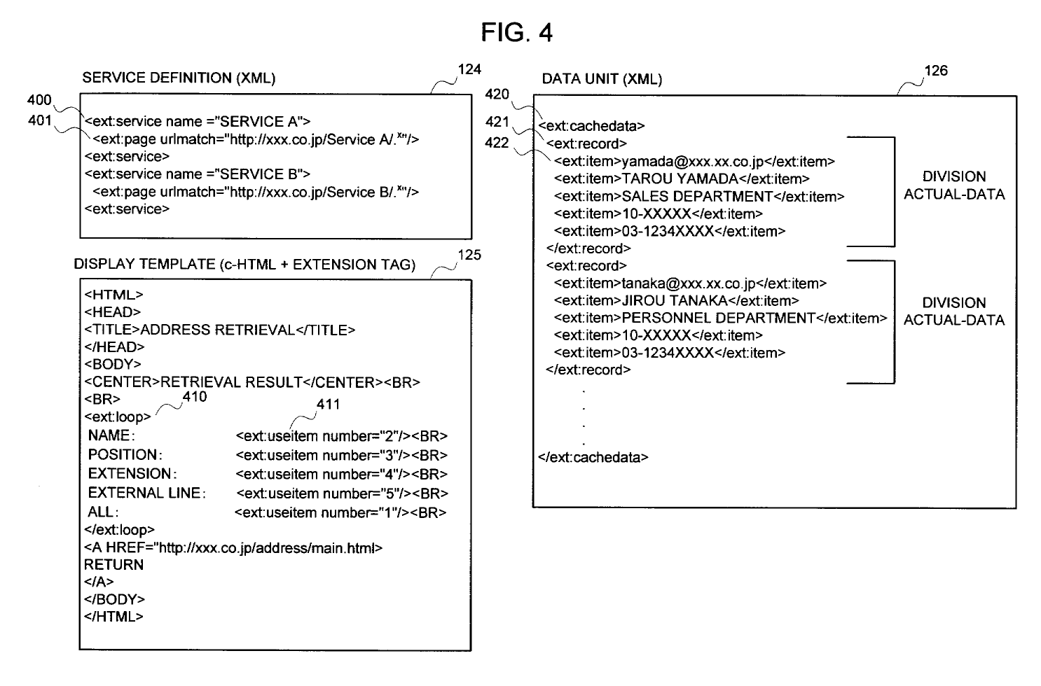

Herein, as one example of the service being requested by the terminal 10, there exists a telephone directory service. In this example, the concept of the division data being stored in the first storing unit is one shown in FIG. 4. Specifically, in a data unit 126, data (division actual-data) such as a name and a telephone number is individually stored for each person being listed in a telephone directory. Further, information (format information) indicating a display format, which allows the division actual-data associated with the telephone directory service of these respective persons to be provided (displayed) to the terminal 10, is listed as one piece of the division data in a display template 125 separately from the above-mentioned data such as each person.

Owing to division of the data in such a manner, for example, addition of a person to the telephone directory incurs only addition of the division actual-data associated with the added person to the data unit 126, and does not incur a change to division actual-data by other persons nor a change to the text of the data of the display template unit 125.

Next, an operation in the case that a service request has been made by terminal 10 will be explained. If this service request is a first-time one, that is, the data associated with this service has not been stored in a second storing means 15 of the server 11, the data server 12 transmits to the server 11 all pieces of the division data that correspond to the requested service. A providing means 14 of the server 11 having received this division data attaches an identifier to each division data to store it in the second storing means 15, and transmits the division data together with this identifier to the terminal 10.

On the other hand, if the service request is a service request made after the first-time one, the providing means 14 of the server 11 compares the division data stored in the first storing means 13 with the division data stored in the second storing means 15, in a case where the division data has been added, newly attaches an identifier to the added division data, stores the added division data together with the identifier in the second storing means 15, and transmits it to the terminal 10. Further, if there is no change to the text of the division data, the server 11 transmits only the identifier attached to this division data to the terminal 10. In addition hereto, if the division data has been deleted, the server 11 does not transmit information associated with this deleted division data to the terminal 10.

Next, an update operation of the terminal 10 having received the division data etc. transmitted from the above-mentioned server 11 will be explained. The terminal 10 knows that the server 11 transmits the division data, the identification information, or the like according to the above-mentioned rule, depending upon an update status of the division data stored in the data server 12. Thus, the terminal 10 having received the division data etc. updates the text of a third storing means 17 according to the above-mentioned transmission rule. For example, upon exemplifying the above-mentioned telephone directory service for explanation, in a case of having received the division actual-data such as the name, and the telephone number being listed in the telephone directory together with the identifier, the terminal 10 determines that a person has been added to the telephone directory, and adds data associated with the added person to the third storing means 17. Thereafter, the terminal 10 provides information associated with the telephone directory including the added data to a user via an information providing means 16.

Next, an exemplary example of the present invention will be explained in details by making a reference to the accompanied drawings.

### A First Example

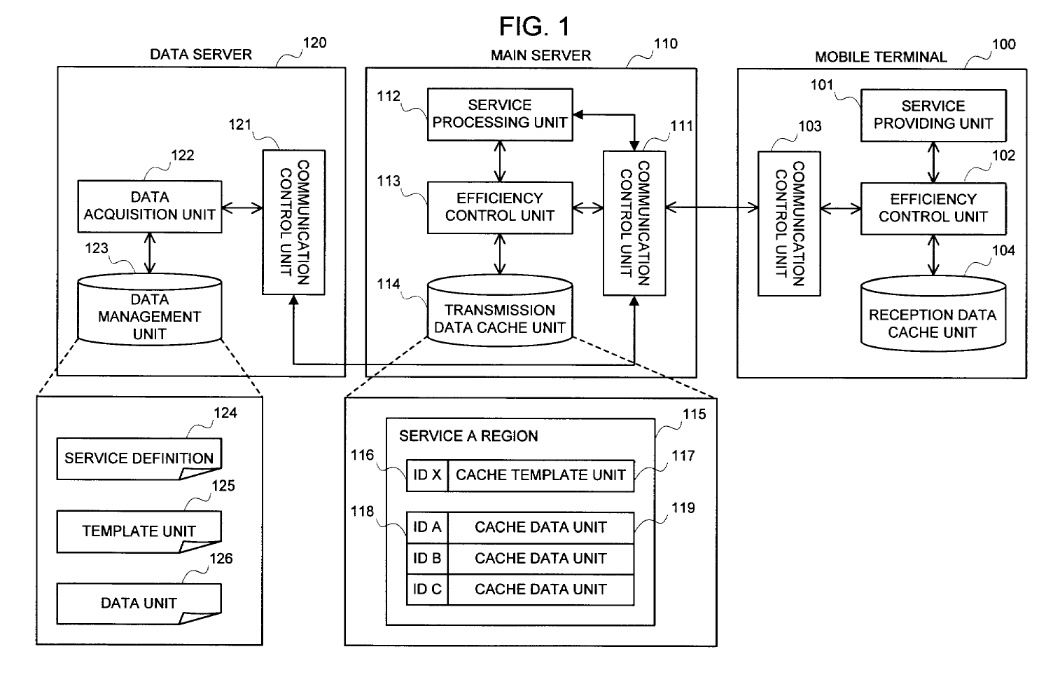

Upon making a reference to FIG. 1, the exemplary example of the present invention has a configuration in which a main server 110 and a mobile terminal 100 are connected via a network, and the main server 110 and a data server 120 are connected via a network.

This communication method by the network connection, which is not directly related to the present invention, is a method in which the usual communication technique can be applied, so its explanation is omitted. Further, in FIG. 1, in order to simplify the explanation, the number of the mobile terminal 100, the main server 110, and the data server 120 was assumed to one, respectively; however two or more are acceptable for each element.

The mobile terminal 100 is a terminal device that holds a keypad or a keyboard as an input interface for inputting information from the user, and holds a monitor etc. of capable of depicting a character and an image as an output interface, which is not shown in the figure. As an example of the mobile terminal, there exists a mobile telephone, PDA (Personal Digital Assistance), a note PC, or the like. This mobile terminal 100 includes a service providing unit 101 for providing a Web browser into which a function of interpreting an extension tag, being a main body of the present invention, has been packaged, a communication control unit 103 for making communication with appliances connected to the outside, an efficiency control unit 102 for processing information received from the main server 110, and a reception data cache unit 104 for preserving information.

The main server 110 is a server that provides information upon receipt of a user's request from the mobile terminal 100. As an example of the main server 110, there exists an enterprise server, a server being hold by an application service provider, or the like.

The main server 110 is configured of a communication control unit 111, being an interface with the external appliance receiving a request from the mobile terminal 100, a service processing unit 112 for confirming the received request, selecting an appropriate server in a case where a plurality of the data servers 120 have been connected via the network, and causing the communication control unit 111, being an interface with the outside, to issue a request via an efficiency control unit 113, and the efficiency control unit 113 for determining whether the information received from the data server 120 is information already transmitted to the mobile terminal, or updated information, and providing a function of preventing already-transmitted information to be retransmitted, and a transmission data cache unit 114 for preserving the transmitted information as history information.

This transmission data cache unit 114 receives from the data server 120 information prepared with the part that is unchangeable for each transmission, out of information described in a Markup language, for example, HTML and c-HTML, assumed to be a template unit, and with the part that is changeable assumed to be a data unit, attaches a data management number that enables the information to be managed individually, and preserves it.

Further, the data being stored into the transmission data cache unit 114 is individually managed for each service that is being utilized. For example, in a case where data “cache template unit” 117 to which a data management number “ID X” 116 has been attached has been preserved in a region of “service A” 115, the user of the mobile terminal 100 makes a request from the efficiency control unit 113 with the data management number “ID X” 116 as a key while utilizing the service A, thereby making it possible to acquire the data stored in the “cache template unit” 117. Further, contrarily hereto, making a request with the “cache template unit” 117 as a key enables the data management number “ID X” 116 to be confirmed. It is assumed that with a combination as well of an ID A 118 and a cache data unit 119, the situation thereof is similar.

The data server 120 is configured of a communication control unit 121 having a function of a Web server, being an interface with the external appliance or the other server, a data acquisition unit 122 for, upon receipt of a request by the main server 110, acquiring information that corresponds to its request from a data management unit 123, a template unit 125 for storing information of a format described in the Markup language, of which data is not changed for each utilization, a data unit 126 for storing raw data that could be changed for each utilization, and a service definition 124, being service identification information that makes information stored in the foregoing template unit 125 and information stored in the foregoing data unit 126 utilizable correspondingly to each other.

In order to simplify the explanation, the number of the set of the service definition 124, the template unit 125, and the data unit 126 was one; however this set may exist in plural. In the exemplary embodiment, the data server 120, upon receipt of a request by the main server 110, provides information, the so-called service is, for example, a telephone directory service for confirming a telephone number of an employee, and a scheduler service for confirming a schedule, the data of which the text is changed, for example, the telephone number of the telephone directory service and the details of the schedule of the scheduler is stored in the data unit 126, and the page of html or c-html for designating an layout or a format, which allows these pieces of the data to be displayed in a due format, is assumed to be the template unit 125.

And, information is stored in the service definition 124 that enables the data being stored in the data unit 126 and the data being stored in the template unit 125 to be managed as an identical contents.

Additionally, the data server 120, which was assumed to be an independent server for a purpose of clarifying a role thereof in FIG. 1, may be assumed to be one part of the function included in the main server 110. Further, it is also acceptable that the service definition 124, the template unit 125, and the data unit 126 are not preserved in the data management 123 of the data server 120, and the main server 110 has the data management unit 123, in which the service definition 124, the template unit 125, and the data unit 126 are preserved, and further, besides it, it is acceptable that the data management unit 123 exists in a server connected to the main server 110 via the network and this data management unit 123 preserves the service definition 124, the template unit 125, and the data unit 126. Herein, in order to simplify the explanation, the explanation will made by employing the configuration in which the server is defined as the data server 120, in which the data management unit 123 exists, in which the service definition 124, the template unit 125, and the data unit 126 exist.

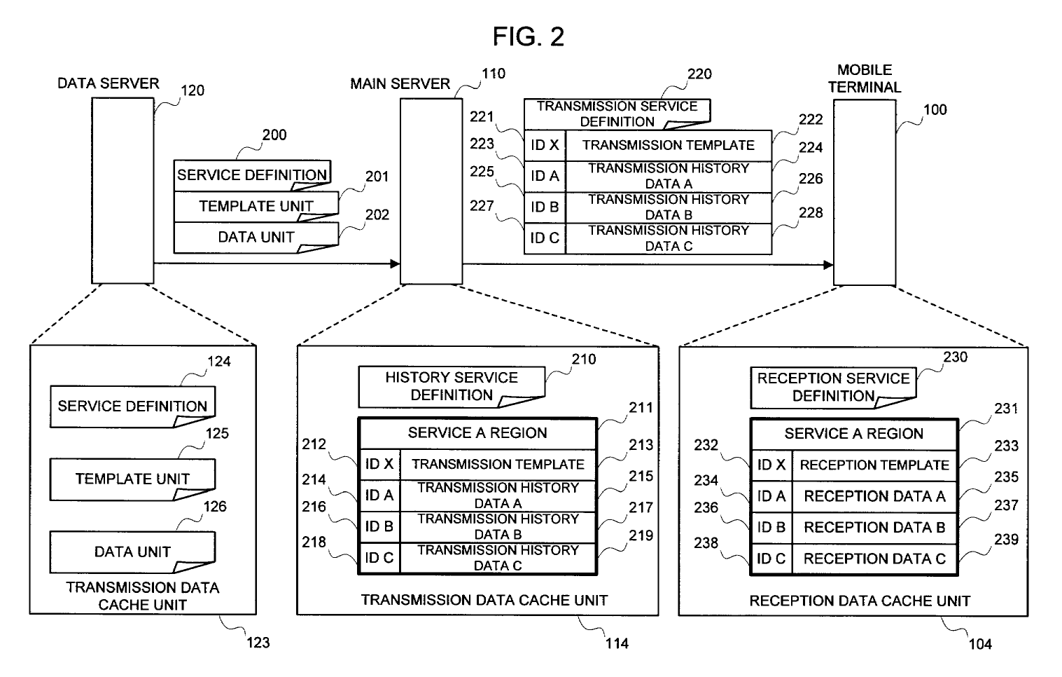

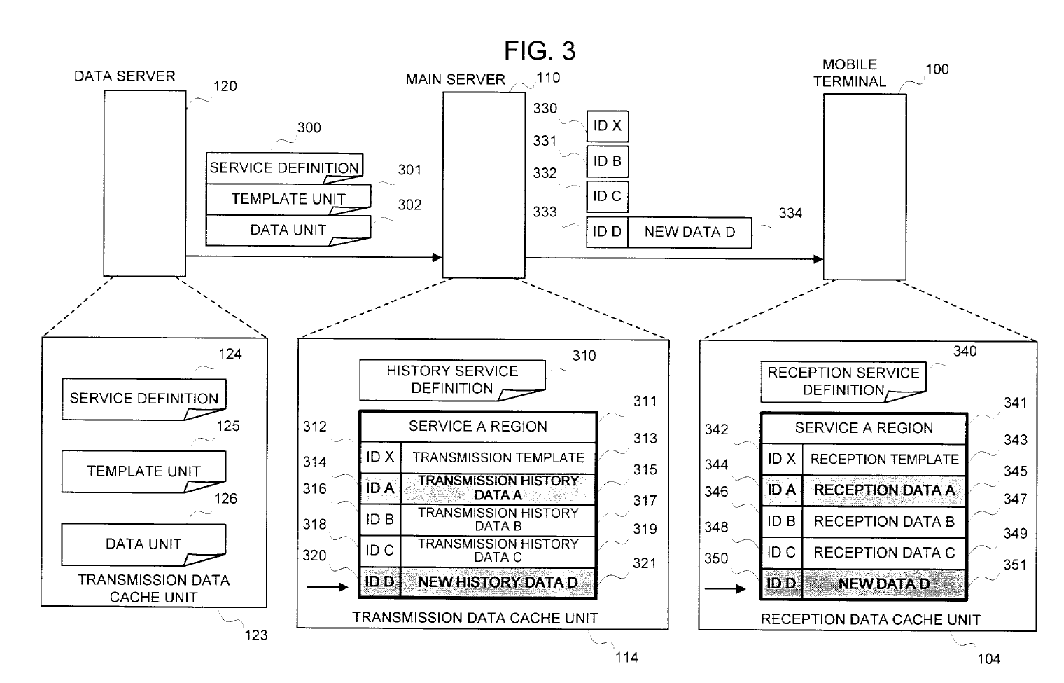

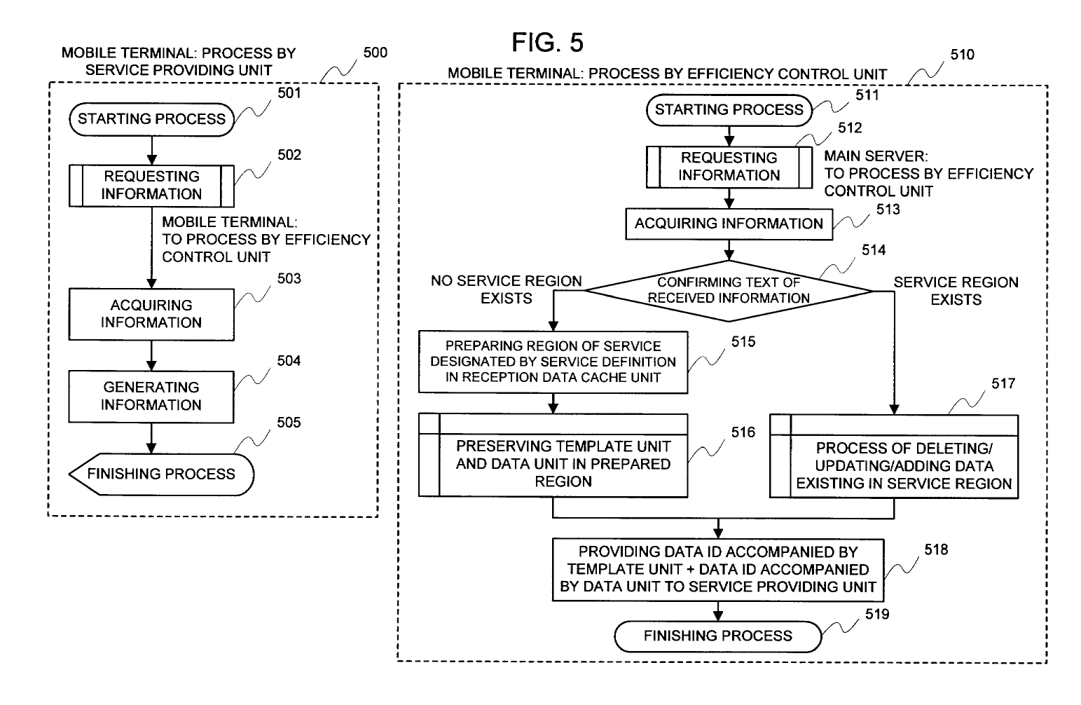

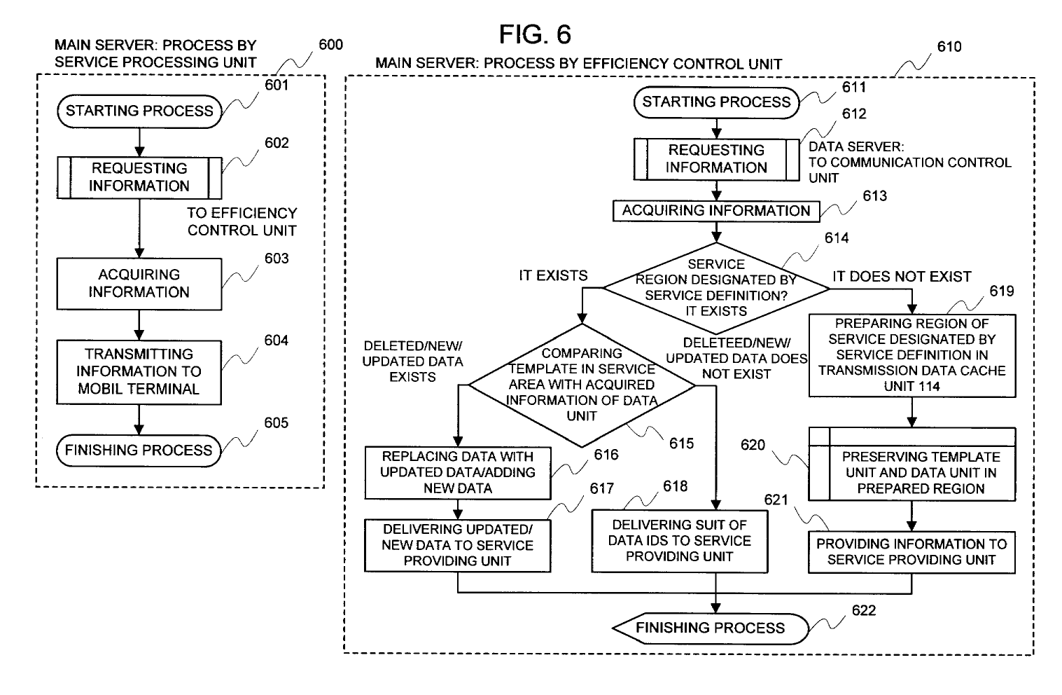

Next, an operation will be explained by making a reference to FIG. 1, FIG. 2, FIG. 3, FIG. 4, FIG. 5, and FIG. 6. Herein, configurations of the data server 120, the main server 110 and the mobile terminal 100 described in FIG. 2 and FIG. 3 are identical to that of the data server 120, the main server 110 and the mobile terminal 100 described in FIG. 1, respectively, so its explanation is omitted.

At first, an explanation of the mobile terminal 100, the main server 110, and the data server 120 in the foregoing configuration will be started in a status in which the reception data cache unit 104 of the mobile terminal 100 holds no data, and further, the transmission data cache unit 114 as well of the main server 110 holds no data.

Herein, assume that the user of the mobile terminal 100 is going to utilize the service. The service being provided by the service providing unit 101 of the mobile terminal 100 to the user indicates a service that enables the user to makes a reference to information by issuing a request to the main server 110 connected to the outsider, and receiving information that corresponds to its request.

This so-called service is, for example, a service that enables an employee of an enterprise (enterprising body) to make a reference to the telephone directory information stored in an in-enterprise server from a destination of an outing (outside the enterprise), or a service that enables an employee to confirm a schedule. The user makes a request to the main server 110, by inputting a family name, a name or the like of a partner, who he/her desires to look for in the case of the service for providing a function of making a reference to the telephone directory, or by inputting a date and a partner that he/her desires to reference in the case of the schedule confirmation.

This request is made, by making a reference to the output interface by the user, which the service providing unit 101 provides, and selecting/inputting an item by the input interface (not shown in the figure), which he/her desires to utilize, from among the reference result. When the input by the user is completed, the process is started (FIG. 5, step 501), the service providing unit 101 transmits URL information caused to correspond to the selected (requested) service, and the information that has been input, being a parameter, respectively, as an information request to the main server 110 from the communication control unit 103, being an interface part that network-connects to the external appliances, via the efficiency control unit 102 (FIG. 5, step 512).

An operation of the main server 110 having received the information request from the mobile terminal 100 via the network will be explained by employing FIG. 6. The main server 110 delivers request information to the service processing unit 112 via the communication control unit 111. The service processing unit 112 having received the request information makes an information request to the efficiency control unit 113 (FIG. 6, step 602). The efficiency control unit 113 having received the information request makes an information request to the data server 120 designated with the URL shown in the received request information via the communication control unit 111 (FIG. 6, step 612).

Herein, an operation of the data server 120 having received the request from the main server 110 will be explained. The data server 120 delivers the request information to the data acquisition 122 via the communication control unit 121.

The data acquisition 122 having received the request information acquires information designated with URL from the data management unit. Information being acquired herein is comprised of a text of the service definition 124, data stored in the template unit 125, data stored in the data unit 126. The service definition 124 is described in an XML format, being a metalanguage, in which the service name and the URL, being information for determining whether its service has been used, are described. The URL assumes a configuration of a host name+a service name, and making a comparison with the URL designated herein makes it possible to determine which service is utilized.

This use service name, for example, as listed in FIG. 4, is designated with, a “name” attribute of <ext:service> tag 400, and the URL indicating this service is designated with a “urlmatch” attribute of <ext:page> tag 401, being an element of the <ext:service> tag 400. Also hereinafter, the case of managing the service that the user of the mobile terminal desires to utilize by employing the service name, as shown in FIG. 4, will be explained. In the present invention, however, the service name does not need to be employed always, and the other identifier, which enables the service to be identified, may be employed instead of the service name.

The template unit 125, for example, as listed in FIG. 4, is configured of a basic “html” tag or a basic “chtml” tag, and two kinds of the extension tags, i.e. a <ext:loop> tag 410 and a <ext:useitem> tag 411 that makes the separated pieces of the data unit 126 displayable by applying them again. The <ext:useitem> tag 411, which has an attribution of “number”, has a function of acquiring information indicated with this attribution from the data unit 126. The <ext:loop> tag 410 has a function of repeatedly incorporating information being held by the data unit 126 until the last line. Owing to these functions, the template unit 125 realizes reconstitution of a screen by re-integrating the data stored in the data unit 126 that exists separately from the template unit 125.

The data unit 126, which is described in an XML format as listed in FIG. 4, is configured of a <ext:cachedata> tag 420, a <ext:record> tag 421, being an element of this tag, and a <ext:item> tag 422. The <ext:cachedata> tag 420 indicates a set of the data by service, the <ext:record> tag 421 indicates a set of individual data, and the <ext:item> tag 422 indicates individual data.

The data acquisition unit 122 transmits the text of the service definition 124, the data stored in the template unit 125, and the data stored in the data unit 126 to the main server 110 via the communication control unit 121. This state is shown in FIG. 2.

Herein, the operation of the main server 110 will be explained again by employing FIG. 2 and FIG. 6. The main server 110 provides the text of the service definition 124, the data stored in the template unit 125, and the data stored in the data unit 126, each of which has been transmitted from the data server 120, to the efficiency control unit 113 via the communication control unit 111. The efficiency control unit 113 having acquired these pieces of the data etc. (FIG. 6, step 613) makes a reference to the text of the service definition 124, makes a reference to the <ext:service> tag 400 to confirm the utilization service name, and confirms whether or not a service A region 211 within the transmission data cache unit 114 being utilized in this service exists (FIG. 6, step 614).

Next, a process by the main server 110 and the mobile terminal 100 in the case that the service A region 211 does not exist, and a process by the main server 110 and the mobile terminal 100 in the case that the service A region 211 exists will be explained.

When the service A region 211 does not exist (when this situation differs from the situation shown in FIG. 2), the service A region 211 designated by the service definition 124 is newly prepared in the transmission data cache unit 114 (FIG. 6, step 619). As a method of preparing the service A region 211, the method of, in the transmission data cache unit 114, directly describing information for identifying the service and the region being used, the method of preparing and utilizing a table for causing the service identification information and the use region to correspond to each other, or the like may be adopted.

Next, the efficiency control unit 113 preserves the data stored in the received template unit 201 as a transmission template 213 in the prepared service A region 211. Further, the efficiency control unit 113 preserves the data stored in the received data unit 202 as a transmission history data A 215, and if the data exists in plural, sequentially preserves the data as transmission history data B 217 and transmission history data C 219 (FIG. 6, step 620).

Further, the efficiency control unit 113 automatically attaches an ID X 212, an ID A 214, an ID B 216, an ID C 218 for managing this preserved data to the transmission template 213, the transmission history data A 215, and the transmission history data B 217 and the transmission history data C 219 correspondingly hereto, respectively.

Herein, a format of the ID being attached by the efficiency control unit 113 may be sequential in some cases, and may be unsequential in some cases so long as it does not exist in the transmission data cache unit 114 and yet is unique. The efficiency control unit 113 preserves the service definition 200 simultaneously received as a history service definition 210 in the transmission data cache unit 114.

When preparing the service region as mentioned above, an efficiency control unit 113 has determined that the utilization of the above service in the mobile terminal 100 is a first-time utilization, and provides to the service processing unit 112 all data of the history service definition 210, the transmission template 213 to which the ID X 212 has been attached, the transmission history data A 215 to which the ID A 214 has been attached, the transmission history data B 217 to which the ID B 216 has been attached, and the transmission history data C 219 to which the ID C 218 has been attached.

The service processing unit 112 having acquired the information (FIG. 6, step 603) transmits the history service definition 210 as a transmission service definition 220 to the mobile terminal 100 via the communication control unit 111 (FIG. 6, step 604). Further, likewise, the service processing unit 112 transmits to the mobile terminal 100 each as well of a transmission template 222 to which an ID X 221 has been attached, a transmission history data A 224 to which an ID A 223 has been attached, a transmission history data B 226 to which an ID B 225 has been attached, and a transmission history data C 228 to which an ID C 227 has been attached.

Next, an operation of the mobile terminal 100 having received the above-mentioned data will be explained by employing FIG. 2 and FIG. 5.

The mobile terminal 100 acquires the above-mentioned data sent from the main server 110 in the efficiency control unit 102 via the communication control unit 103 (FIG. 5, step 513), and confirms the text of the received data (FIG. 5, step 514).

The case that a result of confirmation indicates that the region of the service designated by the text of the received transmission service definition 220 does not exist in the reception data cache unit 104 will be explained below.

In this case, the efficiency control unit 113 newly prepares a service A region 231 with an algorithm identical to that of the efficiency control unit 113 of the main server 110 (FIG. 5, step 515). Next, the efficiency control unit 113 preserves a reception template 233 and an ID X 232 accompanied by it, reception data A 235 to which an ID A 234 has been attached, a reception data B 237 to which an ID B 236 has been attached, and reception data C 239 to which an ID C 238 has been attached in the prepared service A region 231 (FIG. 5, step 516).

Further, it preserves the text of the transmission service definition 220 as a reception service definition 230 in the reception data cache unit 104. After the preservation process is finished, the efficiency control unit 113 provides the ID X 232, the ID A 234, the ID B 236, and the ID C 238 acquired from the main server 110 and preserved in the reception data cache unit 104 to the service providing unit 101 (FIG. 5, step 518).

The service providing unit 101 having received the ID (FIG. 5, step 502) acquires the reception template 233, the reception data A 235, the reception data B 237, and the reception data C 239 from the acquired IDs, and uses the foregoing expansion tag to reconstitute the data. The service providing unit 101 provides the web page reconstituted by utilizing the output interface being held by the mobile terminal to the user. The foregoing explanation is an explanation in the case that the service A region 211 does not exist.

Next, the case that a service A region 311 exists (in a case of Yes in FIG. 6, step 614) will be explained by employing FIG. 3 and FIG. 6.

In this case, the efficiency control unit 113 compares a transmission template 313 preserved in the service A region 311 with the data stored in an acquired template unit 301 (FIG. 6, step 615).

If a result of comparison indicates that the transmission template 313 coincides with the text of the data stored in the acquired template unit 301, the efficiency control unit 113 has determined that the data stored in the acquired template unit 301 has not been updated, and preserves the transmission template 313 within the service A region 311 as it stands.

On the other hand, in a case where a result of comparison of the transmission template 313 preserved in the service A region 311 with the data stored in the acquired template unit 301 (FIG. 6, step 615) indicates that a disagreement between the text of the transmission template 313 and that of the data stored in the template unit 301 has occurred, or that the version number indicating version of the data being attached to the template unit 301 has been renewed, it has been determined that template has been updated, which could lead to the process of replacing the transmission template 313 with the data stored in the received template unit 301.

However, herein, an explanation of the process in the case that the template has not been updated will proceed.

Further, if a result of comparison of the data stored in a received data unit 302 with each of a transmission history data A 315, a transmission history data B 317, a transmission history data C 319 indicates that the transmission history data A 315 does not exists, the efficiency control unit 113 deletes this transmission history data A 315 and an ID A 314 accompanied by it from a service A region 311. Further, if a result of comparison indicates that the data received stored in the data unit 302 does not exists in the service A region 311, the efficiency control unit 113 determines that the data is new data, attaches an ID D 320, and preserves it as a new history data D 321 in the service A region 311.

A history service definition 310 compares the new history data D 321 with the text of the received service definition, and preserves it as it stands if there is no change. When these processes are finished (FIG. 6, step 616), the efficiency control unit 113 delivers an ID X 312 being accompanied by a transmission template 313, an ID B 316 being accompanied by a transmission history data B 317 to which a change has not been made, an ID C 316 being accompanied by a transmission history data C 317 to which a change has not been made, the newly-added new history data D 321, and the ID D 320 to the service processing unit 112 (FIG. 6, step 617).

The service processing unit 112 having received a suit of the above-mentioned data etc. (information) (FIG. 6, step 603) transmits to the mobile terminal 100 an ID X 330, an ID B 331, an ID C 332, and new data 334 to which an ID D 333 have been attached via the communication control unit 111.

Next, an operation of the mobile terminal 100 having received these ID X 330 etc. will be explained by employing FIG. 3 and FIG. 5.

The efficiency control unit 102 of the mobile terminal 100 acquires the above-mentioned data etc. (information) via the communication control unit 103 (FIG. 5, step 513). The efficiency control unit 102 having received the information makes a reference to a reception service definition 340, and confirms which service is utilized from the URL accessed at the moment of having made a request to the main server 110, and determines a service A region 341 to which a reference should be made.

When the efficiency control unit 102 confirms the service A region 341 to which a reference is made, it confirms the text of the received data etc. mentioned above (information) (FIG. 5, step 514), and compares it with the information within the service A region 341 to start a process.

In this example, the efficiency control unit 102 determines that a reception template 343 has not updated and preserves the reception template 343 as it stands because it is only the ID X 330 that it has received with regard to the template.

Further, the ID A 344 does not exist, whereby the efficiency control unit 102 determines reception data A 345 has been deleted and deletes an ID A 344 and the reception data A 345 from the service A region 341.

Further, the ID D 333 does not exist in the service A region 341, whereby the efficiency control unit 102 determines that it is new data and adds an ID D 350 and new data D 351 to the service A region 341.

Further, with regard to the ID B 331 and the ID C 332, only the IDs have been provided, whereby the efficiency control unit 102 determines that the data that corresponds to these IDs has not been updated or deleted, and leaves them as they stands.

When the process within the service A region 341 is finished (FIG. 5, step 517), the efficiency control unit 102 provides an ID X 342, an ID B 346, an ID C 348, and an ID D 350, out of the data etc. (information) received from the main server 110, to the service providing unit 101 (FIG. 5, step 518).

The service providing unit 101 having received the above-mentioned IDs (FIG. 5, step 502) acquires a reception template 343, reception data B 347, reception data C 349, and reception data D 351 from the reception data cache unit 104 based upon the received IDs, and uses foregoing extension tags to reconstitute data (screen).

The service providing unit 101 utilizes the output interface (not shown in the figure) being held by the mobile terminal to provide the reconstituted Web page to the user.

The process above enables the data already transmitted to the mobile terminal to be re-utilized, which can prevent all dada from being transmitted many times, and can realize a reduction in the traffic.

Additionally, during the time that the mobile terminal 100 acquires the information transmitted from the main server 110 via the network, it is also possible to additionally perform a data compression process therefor, and to reduce the communication quantity all the more. Further, it is also possible to additionally perform a process of encrypting the data, which is generated during the time that the mobile terminal 100 acquires the information transmitted from the main server 110 via the network, from a viewpoint of a security.

In the communication technique of the present invention, the main server 110 needs to have a function of pre-settle a cache size of the reception data cache unit 104 of the mobile terminal 100 for a purpose of maintaining the transmission data cache unit 114 of the main server 110 and the reception data cache unit 104 of the mobile terminal 100 so that they are identical to each other. As an example of settling the cache size, the efficiency control unit 102, at the time that a first-time service request has been made by the mobile terminal 100, confirms a physical size of the reception data cache unit 104 that the efficiency control unit 102 itself manages, thereby to confirm the utilizable cache size, and transmits its size information together with a request command to the main server 110.

The efficiency control unit 113 of the main server 110 secures the cache size identical to the size of the size information received in the transmission data cache unit 114 that the efficiency control unit 113 itself manages. When the efficiency control unit 113 has secured the cache size, it transmits a flag etc. for indicating a completion of securing the cache size together with information that is transmitted as a request result, and the efficiency control unit 102 of the mobile terminal 100 secures its cache size in the reception data cache unit 104.

As another example of specifying the cache size, there exists the technique as well in which the main server 110 pre-holds information of the cache size, which is held by each mobile terminal, in a data table etc., at the time that an access has been made by each mobile terminal 100, makes a reference to terminal identification information, which has existed in HTTP header information at the time of the access, confirms the cache size being held by its terminal from the foregoing data table, and decides the cache size.

Additionally, it is also possible to provide this technique as an ASP service. The service providing enterprise has the function of the main server 110 having the efficiency control unit 113, and the contracting enterprise makes an access to its own business server via this main server 110, thereby making a possible to realize communication efficiency and to reduce monthly communication expense. The service providing enterprise, which can provide maintenance of the main server 110 and the main server 110, also can get a reward for this provision from the contracting enterprise.

### A Second Example

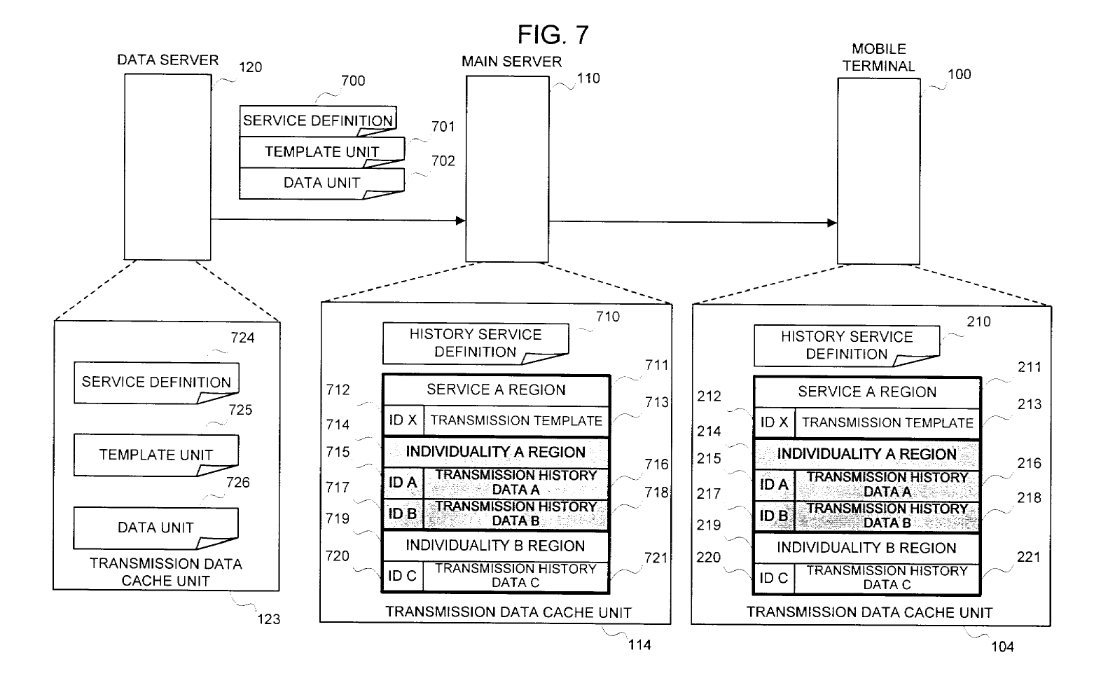

Next, a second exemplary example of the present invention will be explained in details by making a reference to FIG. 1 and FIG. 7.

The region is additionally divided in the service A region 711 of the main server 110 like an individuality A region 714 and an individuality B region 719 as an addition to the configuration of the first exemplary example. Additionally, in order to make the explanation easy, the number of individuality regions was assumed to be two; however three or more are acceptable.

A reference to these individuality regions can be made with the following two techniques.

The first technique is a technique in which the main server 110 having received request information from the mobile terminal 100 specifies the individuality A region 714 that should be utilized in consideration of the request information, and notifies its result to the terminal from the main server 110, and the second technique is a technique in which the mobile terminal 100 making a request, which already knows that the individuality A region is used, makes a request to the main server 110 by designating the individuality A region.

An operation in the first technique will be explained with a configuration of this exemplary embodiment.

With a request by the user of the mobile terminal 100, a request is issued from the mobile terminal 100 to the main server 110. For example, if it is assumed that the service being utilized is a scheduler service that enables a reference to a colleague's schedule, the user can make an access to the URL indicating a main page of the scheduler service at the time of the first request to acquire a list of schedule providing persons including a name of the colleague providing the schedule.

Next, the user makes a reference to the details of the schedule from this list of the names, and, for example, selects a schedule of A person to make a request for it.

In this request, when the ID etc, indicating A person is transmitted to the main server 110 as request information, the main server 110 receives its request and makes a request to the data server 120.

The data server 120, responding to the request, transmits the text of a service definition 700, data being stored in a template unit 725, and data including the schedule information of A person that is stored in a data unit 726. The main server 110 having received these pieces of the data etc. delivers these pieces of the data (information) to the efficiency control unit 113, and further, delivers the request information received from the terminal.

The efficiency control unit 113 having received the information determines the service A region 711 to which a reference is made from the text of the received service definition 700. After the efficiency control unit 113 preserves the text of the service definition 700 as a history service definition 710, it issues an ID X 712 that is unique in the service A region, and preserves the data stored in a received template unit 701 together with the ID.

Next, the efficiency control unit 113 makes a reference to the request information from the terminal, compares this request information with identification information described in head parts of an individuality A region 714 and an individuality B region 719, and determines the individuality region including data associated with this request information. Herein, it is assumed that it has been determined that the individuality A region 714 is utilized.

The efficiency control unit 113 performs the following process for the individuality A region determined to be a region being utilized. If a data unit 702, being the received schedule information of A person, is new information, the efficiency control unit 113 preserves it as transmission history data A 716 and transmission history data B 718, and simultaneously therewith, attaches a unique ID A 715 and a unique ID B 717 hereto, respectively. Additionally, herein, in order to make the explanation easy, the number of the transmission history data was assumed to be two i.e. the transmission history data A 716 and the transmission history data B 718; however three or more are acceptable.

When the preservation process is finished, the efficiency control unit 113 transmits a parameter indicating the individuality A region 714, the preserved history service definition 710, the ID X 712, a transmission template 713, the ID A 715, transmission history data A 716, the ID B 717, and transmission history data B 718 to the mobile terminal 100. The mobile terminal 100 having received the information recognizes the fact that a process similar to the preservation process by the efficiency control unit 113 of the main server 110 is performed for the individuality A region 714 from information indicating the individuality A region 714 received as a parameter, and preserves the information in the reception data cache unit 104.

Further, in the process by the efficiency control unit 113 of the main server 110, if new data or deleted data does not exist in the information received from the data server 120, only the information indicating the individuality A region to which a reference is made is transmitted to the mobile terminal 100.

If the new data exists, the efficiency control unit 113 prepares a set of the new data and its data ID as a parameter to transmit it to the mobile terminal 100. If the deleted data exists, the efficiency control unit 113 prepares only the data ID of the data that should be deleted as a parameter to transmit it to the mobile terminal 100.

If the received information is only information indicating the individuality A region 214, the mobile terminal 100 having received the information determines that there is no change to the information, and delivers all information within the individuality A region 214 within the reception data cache unit 104 to the service providing unit 101.

Further, if the data ID and the main body of the data exist in the received information, the mobile terminal 100 determines that the data is new data, and adds it to the individuality A region 214 within the reception data cache unit 104.

Further, if the received information is only the data ID, the mobile terminal 100 determines that the data has been deleted, and deletes the main body of the data, which has been preserved as a set together with this data ID, from the reception data cache unit 104.

Next, a second technique will be explained.

In the second technique, when a reference is made, for example, to the schedule of A person from a list of the schedule providing persons in the scheduler service, a request is issued from the mobile terminal 100 to the main server 110, and the mobile terminal 100 side makes a reference to its own cache, and grasps the region being used in the efficiency process, thereby to attach information indicating the individuality A region 714 to a parameter.

The main server 110 receives this request, and makes a request to the data server 120. The data server 120, responding to the request, transmits the text of a service definition 724, and the data stored in a template unit 725, the data including the schedule information of A person stored in a data unit 726, and the main server 110 having received these delivers these pieces of the information to the efficiency control unit 113.

The efficiency control unit 113 having received the information determines the service A region 711 to which a reference is made from the text of the received service definition 700.

After the efficiency control unit 113 preserves the text of the service definition 700 as a history service definition 710, it issues an ID X 712 that is unique in the service A region, and preserves the data stored in the template unit 701 together with the ID.

Next, the efficiency control unit 113 extracts an individuality A region 714 from the information indicating the service A region 714 attached to the request parameter from the terminal, and utilizes the data stored herein to perform the following process. It preserves the data stored in a data unit 702, being received schedule information of A person, as transmission history data A 716 and transmission history data B 718, and simultaneously therewith, attaches a unique ID A 715 and a unique ID B 717 hereto.

Additionally, herein, in order to make the explanation easy, the number of the transmission history data was assumed to be two, i.e. the transmission history data A 716 and the transmission history data B 718; however three or more are acceptable.

When the preservation process is finished, the efficiency control unit 113 transmits the text of the preserved history service definition 710, the ID X 712, a transmission template 713, the ID A 715, a transmission history data A 716 and the ID B 717, a transmission history data B 718 to the mobile terminal 100.

The mobile terminal 100 having received this information performs a process similar to the preservation process by the efficiency control unit 113 of the main server 110 for the individuality A region 214 already recognized as a region being utilized.

Similarly to the first technique, in the process by the efficiency control unit 113 of the main server 110, if new data or deleted data does not exist in the information received from the data server 120, only the parameter indicating the individuality A region to which a reference is made is transmitted to the mobile terminal 100. If the new data exists, a set of the new data and its data ID is prepared as a parameter, and if the deleted data exists, nothing is done.

If the received information is only information indicating the individuality A region 214, the mobile terminal 100 having received the information determines that there is no change to the information, and delivers all information within the individuality A region 214 to the service providing unit 101. Further, if the data ID and the main body of the data exist, the mobile terminal 100 determines that the data is new data, and adds it the individuality A region 214. Further, if the data ID etc. has not been received, the mobile terminal 100 determines that the data has been deleted, and deletes the main body of the data, which has been preserved as a set together with this data ID.

In such a manner, utilizing the service such that all information within the individuality A region 714 is used leads to transmission of minimum information without transmitting all IDs and the data caused to correspond hereto, which enables a data communication quantity to be reduced.

Additionally, the mobile terminal 100 may have function of, at the moment of issuing a request to the main server 110, attaching to this request an identifier for confirming whether a mismatch with information within the individuality A region 714 of the main server 110 side has not occurred and a flag for indicating that the identifier has been attached in addition to the information within the individuality A region. This identifier may be prepared by hashing all IDs and the main body of the data within the individuality A region and performing an XOR operation process (exclusive OR) for its result, or the other method, which enables the mismatch to be identified, may be adopted.

When the main server 110 confirms the flag indicating that the identifier indicating the individuality A region 714 has been attached to the request received from the mobile terminal 100, it makes a reference to the individuality A region 714 of the service A region 711, and performs a process of generating an identifier similar to that of the mobile terminal 100 from the information existing in its region. When the main server 110 generates an identifier, it compares the identifier transmitted from the mobile terminal 100 with the identifier generated in the main server 110, and performs the above-mentioned efficiency process if the former agrees with the latter.

If a disagreement occurs, the main server 110 performs an information update process or a delete process for the individuality A region of the transmission data cache unit 114, then removes a mismatch by transmitting all information existing therein to the mobile terminal 100.

Additionally, it is also possible to provide this efficiency technique as an ASP service. The service providing enterprise has the main server 110 having the efficiency control unit 113, and the contracting enterprise makes an access to its own business server (data server) via this main server 110, thereby making it a possible to realize the communication efficiency and to reduce the communication expense. The service providing enterprise, which can provide maintenance of the main server 110 and the main server 110, also can get a reward for this provision from the contracting enterprise.

As mentioned above, the second exemplary example has an advantageous feature that the communication efficiency can be enhanced all the more in the service of utilize all data existing in the reception data cache unit 104 every time.

### A Third Example

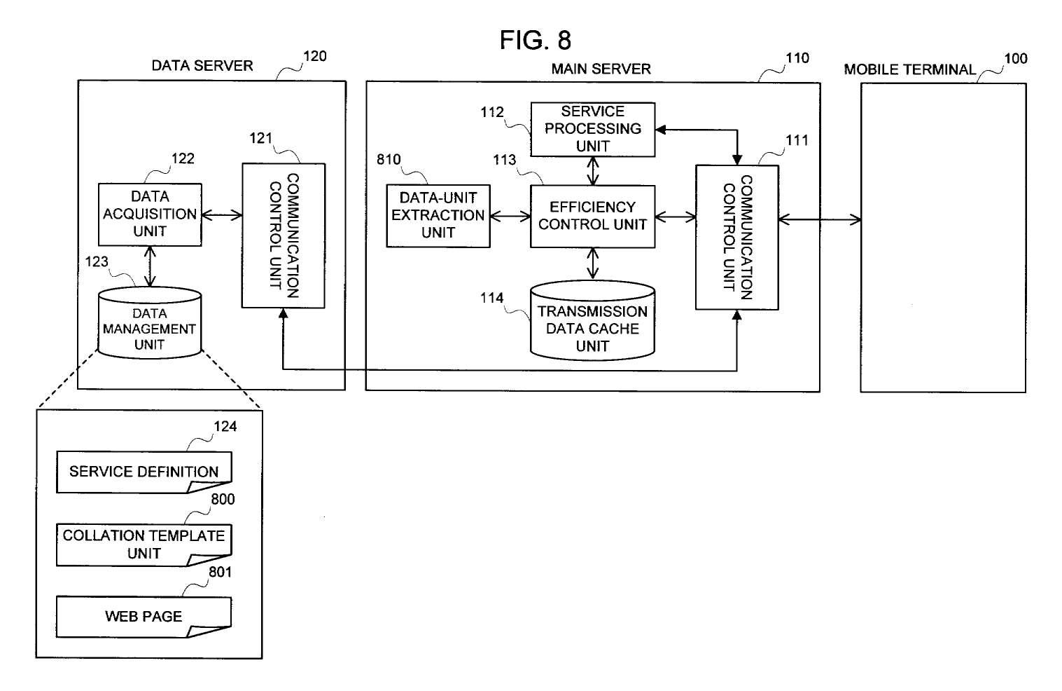

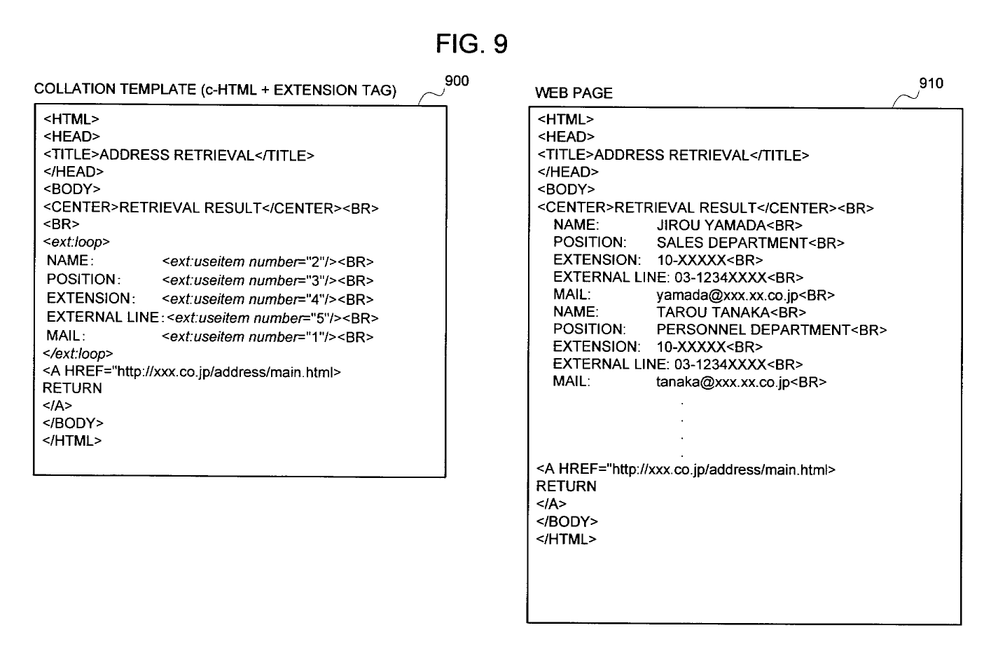

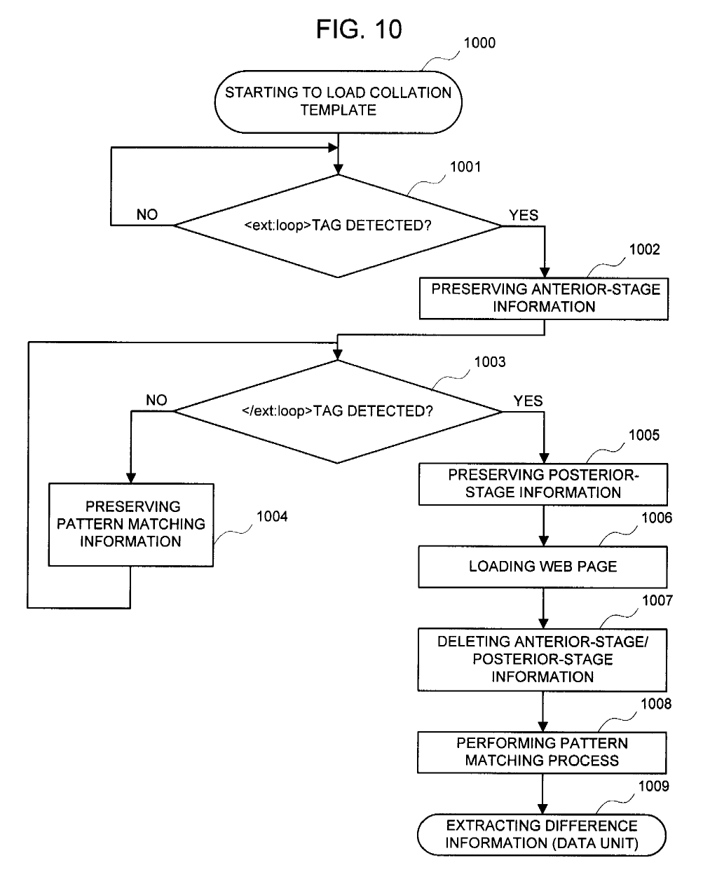

Next, a third exemplary example of the present invention will be explained in details by making a reference to FIG. 8, FIG. 9, and FIG. 10.

The third exemplary example has a function of extracting the data unit from a collation template and a web page. With this, the third exemplary example has an advantageous feature that a Web page writer or a function of automatically preparing the Web page prepares the Web page without separately preparing information of the data unit, thereby making it a possible to realize the communication efficiency.

The main server 110 includes a data-unit extraction unit 810 in addition to a configuration of the first exemplary example. This data-unit extraction unit 810 has a function of comparing a collation template 900 stored in a collation template unit 800 with a text 910 of a Web page 801, and extracting its difference as a data unit.

As an example, the method of extracting difference information from the collation template 900 and the text of the Web page 801 will be explained.

The collation template 900 is a template prepared for extracting a difference with the text 910 of the Web page that is prepared request by request.

When the data-unit extraction unit 810 of the main server 110 starts to load the collation template 900 (FIG. 10, step 1000), and detects an extension tag <ext:loop> (FIG. 10, step 1001), it preserves information of an anterior stage of this extension tag as an anterior-stage information (FIG. 10, step 1002). And, next, until the data-unit extraction unit 810 detects the extension tag </ext:loop> (FIG. 10, step 1003), it detects information generated during its time as a pattern matching information, and preserves it (FIG. 10, step 1004).

On the other hand, the data-unit extraction unit 810 preserves information generated after detecting the extension tag </ext:loop> as posterior-stage information (FIG. 10, step 1005).

When the process of loading the collation template 900 is finished, the data-unit extraction unit 810 next starts to load the text 910 of the Web page (FIG. 10, step 1006). Herein, it firstly deletes the anterior-stage information and the posterior-stage information beforehand preserved from the text 910 of the Web page (FIG. 10, step 1007).

Next, the data-unit extraction unit 810 compares the pattern matching information beforehand preserved with the text 910 of the Web page of which the anterior-stage information and the posterior-stage information have been deleted, thereby to perform a pattern matching process (FIG. 10, step 1008).

Herein, one example of the pattern matching process will be explained. It is assumed that the extracted pattern matching information has a format of, for example, ({name:}.*{position:}.*{extension:}.*{external line:}.*). In this case, when a character sequence (name:, position:, extension:, external line:) shown herein matches that of the text 910 of the Web page of which the anterior-stage information and the posterior-stage information have been deleted, the character sequence that has matched with “.*” (for example, Jirou Yamada) and the character sequence after it are assigned. Finishing a process of assigning “external line:”, being a final character sequence of this pattern signifies a completion of extraction of one-loop portion of the data, and this extracted data, which is enclosed with the extension tags <ext:record> and </ext:record>, is assumed to be one set of the data.

Next, a process similar to the foregoing process is performed to prepare plural sets of the extracted data. When the pattern matching process for the text 910 of the Web page of which the anterior-stage information and the posterior-stage information have been deleted proceeds to the last, the extracted data is coupled, and these are extracted as difference information (FIG. 10, step 1009). This difference information becomes a data unit that is an object of the communication efficiency process.

From now on, an operation at the time that a request has reached the main server 110 from the mobile terminal 100 will be explained in relation to the above-mentioned function of extracting a data unit.

The main server 110 having received a service request from the mobile terminal 100 makes a request to the data server 120. The data server 120, responding to the received request, transmits the text of the service definition 124, the collation template 900 stored in the collation template unit 800, the text 910 of the Web page 801 to the main server 110 via the communication control unit 121.

Additionally, the collation template 900, which is explained in such a format of being held by the data server 120, may be pre-held by the main server 110. Further, with the service definition 124, the situation is similar, and it may be held by the main server 110. In these cases, information being transmitted to the main server 110 side is only the text 910 of the Web page.

The efficiency control unit 113 having received the text of the service definition 124, the collation template 900 stored in the collation template unit 800, and the text 910 of the Web page via the communication control unit 111 delivers the collation template 900 and the text 910 of the Web page to the data-unit extraction unit 810.

The data-unit extraction unit 810 having received the collation template 900 and the text 910 of the Web page compares the former with the latter, and extracts a difference by employing the above-mentioned means, which becomes a data unit.

The data-unit extraction unit 810 delivers the extracted data unit to the efficiency control unit 113.

Upon receipt of the data unit, the efficiency control unit 113 interprets the fact that preservation region of the template is empty as first utilization, preserves the collation template 900 in the transmission data cache unit 114, and preserves the extracted information as a data unit in the transmission data cache unit 114.

The efficiency control unit 113 transmits a suit of the data unit with the collation template 900 as a display template to the mobile terminal 100. Additionally, the display template does not need to be identical to the collation template 900, and the display template having an appearance changed, to which an extension tag that enables the data unit to be incorporated has been attached, may be prepared separately.

The mobile terminal 100 having acquired a suit of the display template and the extracted information reconstitutes the Web page by applying the data unit by use of the extension tag described in the display template with a process similar to the process explained in the first exemplary embodiment.

If, in the request made by the mobile terminal 100 after the first-time request, there is no change to the collation template 900 received from the data server 120 and to the display template preserved in the transmission data cache unit 114, the efficiency control unit 113 performs the efficiency process for the data unit extracted by the data-unit extraction unit 810, and transmits only difference information generated as a result to the mobile terminal 100. With this, a Web page writer or a function of automatically preparing the Web page prepares the Web page as usual without separately preparing information of the data unit, thereby making it possible to realize the communication efficiency.

Additionally, it is also possible to provide this efficiency technique as an ASP service. The service providing enterprise has the main server 110 that has the efficiency control unit 113 and has preserved the collation template 900, and the contracting enterprise makes an access to its own business server via this main server 112, thereby makes it possible to realize the communication efficiency and to reduce the monthly communication expense from a result of a comparison with the collation template 900. The service providing enterprise, which can provide maintenance of the main server 110 and the main server 110, also can get a reward for this provision from the contracting enterprise.

### A Fourth Example

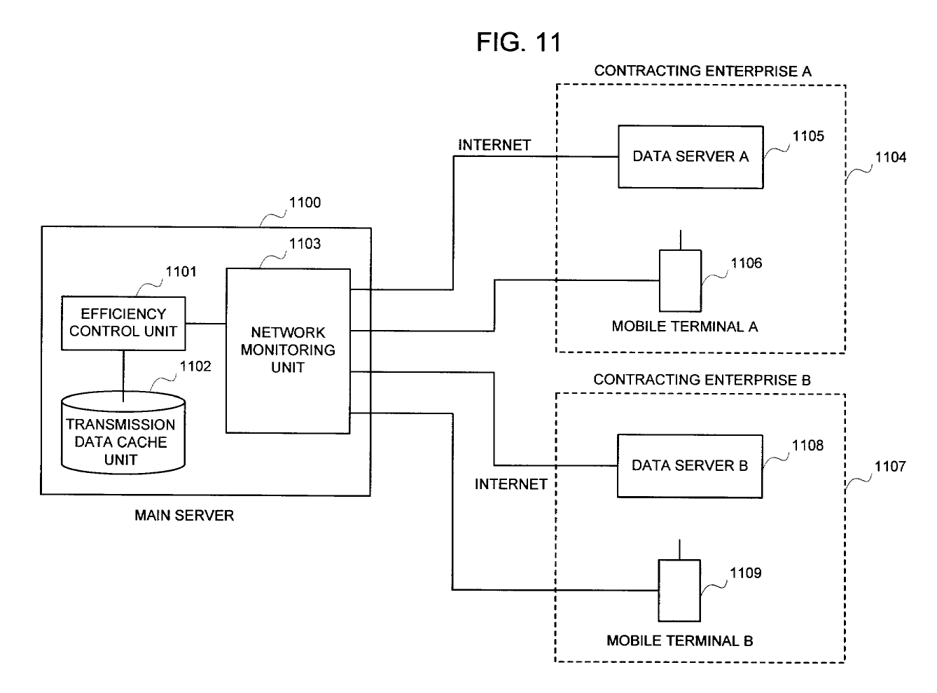

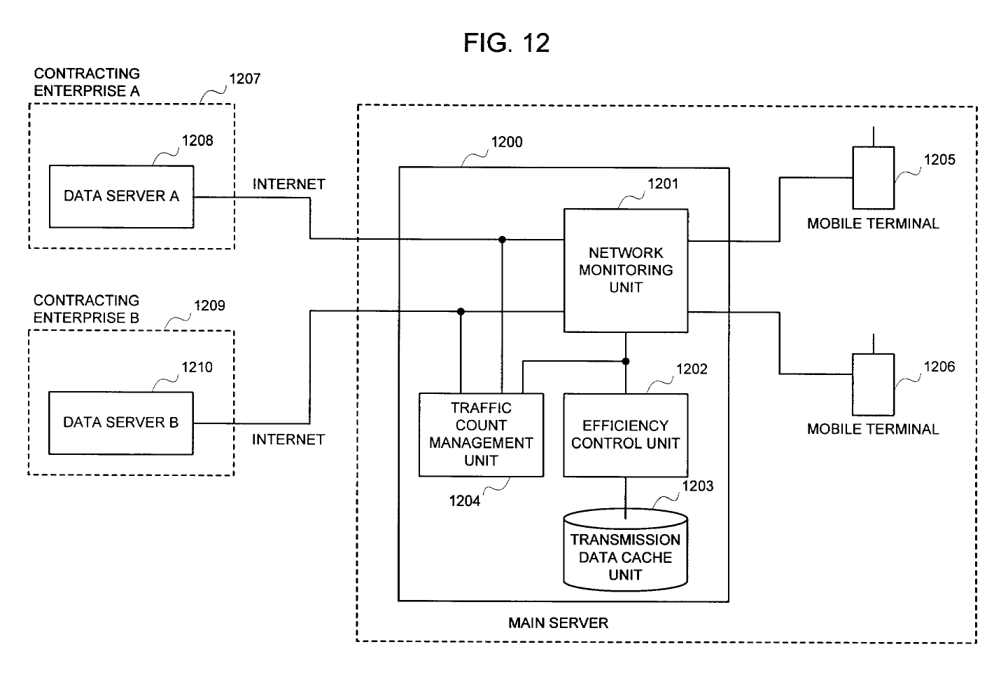

A fourth exemplary example of the present invention will be explained in details by making a reference to FIG. 11 and FIG. 12.

The fourth exemplary example has an advantageous feature that the enterprise having a business server (data server) assigns an operation of a main server for performing the communication efficiency process to the outsider at the moment that an employee belonging hereto makes an access to the data server from the mobile terminal to acquire information, and the enterprise having this main server can get a reward by adding a function of monitoring a network to the main server.

A contracting enterprise A 1104 and a contracting enterprise B 1107 have a data server 1105 and a data server 1108, respectively, and employees belonging to the contracting enterprises have a mobile terminal 1106 and a mobile terminal 1109, respectively.

The enterprise providing the communication efficiency explained in the first exemplary example has a main server 1100, and the main server 1100 has a network monitoring unit 1103, which is indicative of the advantageous feature of this exemplary embodiment. This network monitoring unit 1103, which has an information table of the mobile terminals being held by employees of the contracting enterprise, can identify which enterprise the terminal making an access to the main server 1100 belongs to. Further, the network monitoring unit 1103 has a function of, for each terminal, summing up the number of times of its access, the utilization communication quantity, the communication fee accompanied by it, and an effect of the communication efficiency.

The mobile terminal 1106 and the mobile terminal 1109 making an access to the main server 1100 may be a terminal supplied to the employee by the contracting enterprise A 1104 and the contracting enterprise B 1107, respectively, and may be a belongings of the employee, respectively. Further, in order to make the explanation simple, a format in which two enterprises, i.e. the contracting enterprise A 1104 and the contracting enterprise B 1107 used the main server 110 was adopted; however three enterprises or more may use the main server 1100. Further, the employs as well having the mobile terminal of each enterprise may exist in plural. It is assumed that the contracting enterprise A 1104 and the contracting enterprise B 1107 make a contract of utilizing the service for the communication efficiency with the enterprise having the main server 1100, respectively.

Both of the contracting enterprise A 1104 and the contracting enterprise B 1107 are identical to each other in a method of utilizing the main server 1100, so hereinafter, the contracting enterprise A 1104 is explained with it at the center. It is assumed that the employee belonging to the contracting enterprise A 1104 has the mobile terminal A 1106. The employee firstly downloads the software for realizing the communication efficiency process explained in the first exemplary embodiment into this mobile terminal A 1106 from the main server 1100. After the downloading of the software into the mobile terminal A 1106 is completed, the employee start to utilize the service from this software. The so-called service is a service of requesting information of a data server A and acquiring its result.

When the mobile terminal A 1106 makes a request for information, the request is firstly issued to the main server 1100 via the network. The network monitoring unit 1103 of the main server 1100 detects which mobile terminal has issued the request based upon information for identifying the mobile terminal A 1106, and an information table for determining that this mobile terminal A 1106 belongs to the contracting enterprise A 1104, and decides a data server A 1105 of a connectee. The network monitoring unit 1103 having detected that its request is a request from the mobile terminal A 1106 issues this request to the data server A 1105 of the contracting enterprise A 1104.

The data server A 1105 having received the request transmits information having a c-HTML format that corresponds to its request toward the main server 1100 via Internet. Upon receipt of the information, the main server 1100 provides its information to an efficiency control unit 1101, which executes an efficiency process similar to the process explained in the first exemplary embodiment, and returns the processed information to the network monitoring unit 1103. Simultaneously therewith, the efficiency control unit 1101 preserves the history information in the transmission data cache unit 1102. Additionally, it is assumed that, in the transmission data cache unit 1102, the preservation region of the history is divided contracting enterprise by contracting enterprise, and the divided region is furthermore divided mobile terminal by mobile terminal.

The unique identification information that the mobile terminal attaches standardizedly at the time of making communication makes it possible to determine the region assigned to the contracting enterprise A 1104, which furthermore makes it possible to determine the region assigned to the mobile terminal A 1106.

Further, the parameter attached at the time of making a request makes it possible to determine the region assigned to the mobile terminal A 1106, which furthermore makes it possible to determine the region assigned to the service being utilized.

The network monitoring unit 1103 transmits the information for which the communication efficiency process has been performed to the mobile terminal A 1106. The mobile terminal A 1106 having received the information performs the process explained in the first exemplary embodiment with the communication efficiency function integrally accommodated in the pre-downloaded software.

With this exemplary embodiment, the contracting enterprise rents the main server performing the communication efficiency process, utilizes it for the communication efficiency process, and reduces the charge of communication between the wireless networks being used by the mobile terminal, and the enterprise having the main server receives a contract charge and a reward for an operation management, further provides the monthly service use quantity of the employee of the contracting enterprise and an effect of the communication efficiency as an added value by a function of monitoring a network, and can get a reward therefor.

Further, providing not only the main server but also the mobile terminal to the contracting enterprise having the data server enables the effect of the first exemplary example to be obtained at the moment that the mobile terminal makes an access to the business server (data server) to acquire information. It will be explained below by employing FIG. 12.

A contracting enterprise A 1207 has a data server A 1208. The employee of the contracting enterprise A 1207 makes an access to this data server A 1208 from the mobile terminal to acquire information, and makes a contract of using a main server 1200 for a purpose of obtaining the effect of the first exemplary embodiment. Further, simultaneously therewith, the employee makes a contract of renting the mobile terminal with the enterprise providing the service by the main server 1200. These mobile terminals 1205 and 1206 may have the communication efficiency function integrally pre-accommodated, or may download the software having the communication efficiency function from the main server 1200 at the time of starting the utilization. The employee belonging to the contracting enterprise A makes a request for information to a data server A 1208 by using a mobile terminal 1205. This request is sent to the main server 1200, and the main server 1200 having received this request determines a request destination in a network monitoring unit 1201, and transmits this request to a data server A 1208 of a contracting enterprise A 1207 via Internet. The data server 1208 having received the request sends c-HTML-based information that corresponds to its request to a main server 1200 via the network similarly to the first exemplary embodiment.

The network monitoring unit 1201 having received the information sends its information to an efficiency control unit 1202. The efficiency control unit 1202 performs a communication efficiency process similar to that of the first exemplary embodiment. A determination of the reference region at this moment is made, by adopting a method similar to the foregoing method. The efficiency control unit 1202 sends the processed information to the network monitoring unit 1201. The network monitoring unit 1201 having received the processed information provides the information to a mobile terminal 1205, being a requester. The mobile terminal 1205 having received the information for which the communication efficiency process has been performed performs the process with a method similar to the method described in the first exemplary example in communication efficiency control unit, thereby enabling information to be referenced.

In this exemplary embodiment, each enterprise itself does not hold the main server, but it utilizes the communication efficiency process, thereby making it a possible to reduce an expense of communication in the wireless network of the mobile terminal being used by the employee.

Further, each enterprise, which has made a contract of utilizing/servicing the mobile terminal with the enterprise having the main server, pays a monthly use fee of the mobile terminal to this enterprise; however, at that moment, this exemplary embodiment can contribute to a reduction in the mobile terminal fee of the enterprise because, with the situation of the utilization by the mobile terminal, a traffic count management unit 1204 counts only the traffic generated by connecting to and utilizing the data server, being a business utilization portion, which is charged to its enterprise, and the utilization portion other than the business utilization portion, being a private utilization portion, is charged to the employees using the mobile terminal.

Further, it becomes possible to provide the information of the use quantity, the information as to the degree to which the communication efficiency has been accomplished, or the like as added value, and to get a reward for an operation management and maintenance.

Above, in the explanation of each exemplary embodiment, the object of the present invention was the Web contents (stationary image data) that were displayed in the mobile terminal. However, the object of the present invention is not always limited to the stationary image data that is displayed in the mobile terminal, and voice data or moving image data, which can be provided from the mobile terminal, is acceptable. Classifying these pieces of the voice data and the moving image data as well into the service definition, the template and the data, which are preserved by the data server, makes it possible to realize an operation similar to the operation explained above, and to attain an equivalent effect, being a suppression of the retransmission.

Further, needless to say, the operation of the main server 110 of the present invention is realized in a hardware manner, and the main server 110, being a computer machine, executes a program for executing each means mentioned above, thereby enabling the operation to be realized in a software manner. This program, which is preserved in a magnetic disc, a semiconductor device, or a record medium in addition hereto, is loaded into the main server 110 from its record medium, and controlling its operation allows the foregoing function to be realized.

Further, needless to say, the operation of the mobile terminal 100 as well of the present invention is realized in a hardware manner, and the mobile terminal 100, being a computer machine executes a program for executing each means mentioned above, thereby enabling the operation to be realized in a software manner. This program, which is preserved in a magnetic disc, a semiconductor device, or a record medium in addition hereto, is loaded into the mobile terminal 100 from its record medium, and controlling its operation allows the foregoing function to be realized.

1. A data providing system for providing data responding to a terminal's service request, characterized in comprising:
a first storing means in which service date that is plurally divided and is updated for each divided division data has been stored; and
a providing means for attaching an identifier to said division data responding to a first-time service request made by the terminal, providing to the terminal the division data to which said identifier has been attached, comparing the service data of said first storing means with the service data being comprised of the division data transmitted to said terminal responding to a service request made after the first-time one by the terminal, newly attaching an identifier to updated division data out of the service data, and providing to the terminal this division data to which the identifier has been newly attached.

2. A data providing system for providing a service responding to a terminal's service request, characterized in comprising:
a first storing means in which service date that is plurally divided and is updated for each divided division data has been stored;
a second storing means for preserving the division data of the transmitted service data together with an identifier responding to a request for the service; and
a providing means for comparing the service data stored in said first storing means with the service data stored in said second storing means, in a case where the service data stored in said first storing means has been updated, attaching a new identifier to the division data of this updated service data to preserve it in said second storing means, and providing its division data together with the identifier to said terminal.

3. The data providing system according to one of claim 1 and claim 2, characterized in that said providing means is configured so that, with the division data of the not-updated service data, it provides only the identifier, and with the division data of the updated service data, it provides the updated division data and the identifier attached to this division data.

4. The data providing system according to one of claim 1 to claim 3, characterized in that said division data is comprised of at least the division actual-data obtained by dividing actual data of the service being provided according a predetermined rule, and format information, being information of a format for providing said division actual data caused to correspond to said division actual data over the terminal.

5. The data providing system according to claim 4, characterized in that said division actual-data and said format information have been stored in said second storing means for each of said services being provided.

6. The data providing system according to one of claim 1 to claim 5, characterized in that said first storing means and said providing means are connected via a communicating means.

7. The data providing system according to one of claim 1 to claim 6, characterized in that said storing means and said terminal belong to an identical enterprising body.

8. A data providing method of providing a service responding to a terminal's service request, characterized in:
storing division data obtained by dividing data of the service being provided;
attaching an identifier to the division data constituting the service data of said service responding to a first-time service request made by the terminal, transmitting to the terminal the service data to which said identifier has been attached, and
comparing the service data of said storing means with the service data transmitted to said terminal responding to a service request made after the first-time one by the terminal, and transmitting the updated division data together with the identifier to said terminal.

9. A data providing method of providing to a terminal service data that is plurally divided and is updated for each division data, characterized in comprising:
at the moment of providing said service data, attaching an identifier for each division data obtained by dividing said service data to transmit it to the terminal;
preserving the transmitted division data together with the identifier; and
comparing the updated service data with the division data, which has been stored at the time of said transmission, newly attaching an identifier to the updated division data to transmit it to said terminal, and storing said updated division data and its identifier.

10. A server for transmitting to a terminal data of a service that is comprised of plural pieces of division data stored in a storing means, characterized in comprising:
the storing means; and
a transmitting means for:
attaching an identifier to the division data constituting the service data of said service responding to a first-time service request made by said terminal, and transmitting to the terminal the service data to which said identifier has been attached; and
comparing the service data of said storing means with the service data transmitted to said terminal responding to a service request made after the first-time one by said terminal, and transmitting the updated division data together with the identifier to said terminal.

11. A server for transmitting to a terminal service data that is stored in a data server and is updated for each division data plurally divided, characterized in comprising:
a storing means in which the service date transmitted to said terminal is stored with an identifier attached for each division data;
an update confirming means for comparing the service data of said data server with the service data stored in said storing means for each division data to confirm whether the service data of said data server has been updated; and
a providing means for, in a case where it has been confirmed by said update confirming means that the service data of said data server has been updated, attaching a new identifier to the division data of the updated service data to cause said storing means to store it, and providing the updated division data together with the identifier to said terminal.

12. A program of a server for transmitting to a terminal data of a service that is comprised of plural pieces of division data stored in a storing means, characterized in causing said server to execute the processes of:
attaching an identifier to the division data constituting the service data of the said service responding to a first-time service request made by said terminal, and transmitting to the terminal the service data to which said identifier has been attached; and
comparing the service data of said storing means with the service data transmitted to said terminal responding to a service request made after the first-time one by said terminal, and transmitting the updated division data together with the identifier to said terminal.

13. A program of a server for transmitting to a terminal service data that is stored in a data server and is updated for each division data plurally divided, characterized in causing the server to execute:
an update confirmation process of, for each division data, comparing the service data of said data server with service data transmitted to said terminal, to which an identifier has been attached, to confirm whether the service data of said data server has been updated; and
a providing process of, in a case where it has been confirmed that the service data of said data server has been updated in said update confirmation process, attaching a new identifier to the division data of the updated service data to storing it, and providing the updated division data together with the identifier to said terminal.

14. A data server for providing data to a main server transmitting updated data together with an identifier to a terminal, characterized in comprising:
a storing means in which division data obtained by dividing data corresponding to a service so that said main server is enabled to identify the updated data has been stored;
an update managing means for managing an update of the division data for each of said division data; and
a transmitting means for transmitting the division data stored in said storing means responding to a request for the data that corresponds to the service by said main server.

15. The data server according to claim 14, characterized in that an update in said update managing means is made for each division data.

16. A network system in which a mobile terminal, a main server for providing information to the mobile terminal, and a data server for, upon receipt of a main server's request, providing information have been connected via a network, characterized in that:
said mobile terminal comprises an efficiency control unit and a reception data cache unit;
said main server comprises a communication control unit and a transmission data cache unit;
said data server comprises a communication control unit and a data management unit;
said data management unit of the data server comprises a service definition, and information of a template unit and a data unit;
at the moment of providing information that said main server has, the transmission data cache unit of said main server maintains a text of the reception data cache unit of said mobile terminal so that it is identical to that of the transmission data cache unit; and
said efficiency control unit confirms the text of said transmission data cache unit to determine whether it has been already transmitted.

17. The network system according to claim 16, characterized in that, at the moment of having received the service definition of said data management unit, said efficiency control unit secures a region in said transmission data cache unit service by service from information described therein.

18. The network system according to one of claim 16 and claim 17, characterized in that said efficiency control unit makes a matching between URL to which an access is being made and a service region to which a reference should be made from information described in the service definition of said data management unit.

19. The network system according to one of claim 16 to claim 18, characterized in that:
at the moment of having received the template unit within said data server, in a case where its information exists in said transmission data cache unit, said efficiency control unit confirms whether or not the information has been updated, and in a case where its information has been updated and in a case where its information does not exist, performs an update process or a preservation process, and thereafter, transmits the template unit to said mobile terminal; and
said efficiency control unit replaces the information of the reception data cache unit with the transmitted template unit, thereby to maintain texts of said transmission data cache unit and said reception data cache unit so that they are identical.

20. The network system according to one of claim 16 to claim 19, characterized in that:
at the moment of having received the data unit within said data server, said efficiency control unit confirms whether or not its information exists in said transmission data cache unit, determines that it is new data if the information does not exists, performs a preservation process, and thereafter, transmits the new data toward said mobile terminal; and
said efficiency control unit adds the new data to the reception data cache unit, thereby to maintain texts of said transmission data cache unit and said reception data cache unit so that they are identical.

21. The network system according to one of claim 16 to claim 19, characterized in that:
at the moment of having received the data unit within said data server, said efficiency control unit confirms whether or not its information exists in said transmission data cache unit, determines that its information is new data if it does not exists, attaches an ID for identifying the new data to perform a preservation process for said transmission data cache unit.

22. The network system according to one of claim 16 and claim 17, characterized in that, at the moment that said main server secures a region of the transmission data cache unit, said efficiency control unit confirms a size of said reception data cache unit that can be secured in said mobile terminal, and secures said transmission data cache unit having an identical size.

23. The network system according to one of claim 16 and claim 17, characterized in that said efficiency control unit subdivides the region of the transmission data cache unit secured by said main server for each service being utilized, and furthermore subdivides its region for each piece of information being managed.

24. A network system in which a mobile terminal, a main server for providing information to the mobile terminal, and a data server for, upon receipt of a main server's request, providing information have been connected via a network, characterized in that:
said main server, responding to a request by said mobile terminal, makes a request for information to said data server, compares said template unit and a Web page by a data-unit detection unit upon receipt of the information, determines whether or not the information has been already transmitted to said mobile terminal with a difference assumed to be a data unit, and transmits only an ID for identifying the information to said mobile terminal in a case where it has already been transmitted; and
said mobile terminal grasps information being used from the received ID.

25. The network system according to claim 24, characterized in that said main server comprises a network monitoring unit for monitoring an access by said terminal, and calculating a quantity of the utilized information.

26. The network system according to claim 24, characterized in that said main server comprises a network monitoring unit for monitoring an access by said mobile terminal and calculating a utilization fee from a result of measuring a quantity of the utilized information.

27. The network system according to claim 24, characterized in that an enterprise holding said main server has a contract relation with other enterprises, and provides communication efficiency in a value for receiving a contract fee from the other enterprises.
